(19) United States
(12) Patent Application Publication
(10) Pub. No.: US 2010/0021607 A1
(43) Pub. Date: Jan. 28, 2010

(54) FRUIT PRODUCTS CONTAINING OMEGA-3 FATTY ACIDS

(76) Inventors: Bernhard H. Van Lengerich, Plymouth, MN (US); Goeran Walther, Plymouth, MN (US)

Correspondence Address: GENERAL MILLS, INC., P.O. BOX 1113, MINNEAPOLIS, MN, 55440, US

(21) Appl. No.: 12/507,194

(22) Filed: Jul. 22, 2009

Related U.S. Application Data
(60) Provisional application No. 61/082,795, filed on Jul. 22, 2008.

(51) Int. Cl. C11B 5/00

(52) U.S. Cl. 426/541

(57) ABSTRACT

A fruit product containing a readily oxidizable polyunsaturated fatty acid, such as omega-3 fatty acids, may be prepared by cooking a fruit base composition to obtain a cooked fruit base composition, cooling the cooked fruit base composition, admixing the fruit base composition with an oil which contains at least one readily oxidizable polyunsaturated fatty acid. Additionally, an acidic antioxidant for preventing oxidation of the at least one polyunsaturated fatty acid; and at least one polyol for providing mobility for the acidic antioxidant is admixed with the cooked fruit base composition to obtain an at least substantially homogeneous mixture, which may be formed into pieces.

### CROSS REFERENCE TO RELATED APPLICATIONS

This application claims priority of co-pending U.S. Provisional Patent Application Ser. No. 61/082,795, filed Jul. 22, 2008 for “Fruit Products Containing Omega-3 Fatty Acids” in the names of Bernhard H. van Lengerich and Goeran Walther, the disclosure of which is herein incorporated by reference in its entirety.

### FIELD OF THE INVENTION

The present invention generally relates to gelled food products containing readily oxidizable polyunsaturated fatty acids (PUFAs), and more particularly, to fruit products containing omega-3 fatty acids, and methods for making the fruit products where the free fatty acids such as omega-3 fatty acids are stabilized against oxidation.

### BACKGROUND OF THE INVENTION

Prophylactic and therapeutic benefits of PUFAs such as omega-3 fatty acids and their role as anti-inflammatory agents are well-proven. Recent clinical studies have further suggested that consumption of sufficient amounts of these polyunsaturated fatty acids may be adequate for intervention treatment for animals and humans suffering from rheumatoid arthritis. Dietary sources of PUFAs such as omega-3 fatty acids can be found mainly in foods from marine sources such as algae and fish. In most populations, however, the nutritional benefits of PUFA compounds cannot be realized due to the low consumption of fish and edible algae. With the U.S. Food and Drug Administration's current allowance for health claims relating to intake of omega-3 fatty acids for protection from heart disease, there is an increased interest in fortifying food products with these components. One main problem that hinders the incorporation of PUFA oils into processed foods is the oil's high degree of unsaturation, its susceptibility to oxidation and the subsequent deteriorative effects on flavor and aroma of the oil.

The sensitivity of PUFA oils to oxidation generally restricts its unprotected use to low temperature, short life food such as yogurt or cooled beverages, such as orange juice and milk. For long shelf life dry food such as cereal or granola bars, omega-3 oils generally need to be encapsulated for oxidation protection. Commercially available PUFA encapsulated products are mostly spray dried powders which generally exhibit unacceptable sensory attributes. Also, products which may exhibit bulk stability often fail in application studies after two or three weeks in accelerated shelf life testing at 55° C. which is approximately the equivalent of six or nine month stability, respectively at room temperature.

The encapsulation of PUFA oils in small granulated pellets may be employed to increase oxidative and sensorial stability to four weeks or more in accelerated storage at 55° C. which is approximately the equivalent of one year or more at room temperature, which is a desirable extended shelf life for ready-to-eat cereals and granola bars. However, encapsulated PUFA pellets still need to be handled very carefully and not treated with excess heat, moisture, or high shear forces during food processing. Also, a dry pellet may not be compatible in texture with certain types of foods.

Also, in encapsulating a component in a matrix, the matrix material is generally heated to a sufficiently high temperature to provide a plasticized mass which facilitates embedding or coating of the component. Upon cooling, the matrix material hardens or becomes solidified and protects the encapsulant from undesirable or premature reaction. Grinding of a solidified or glassy product to obtain a desired particle size for incorporation in foods or beverages generally results in the formation of irregularly-shaped pieces and rough surfaces. Irregularly shaped pieces and creviced surfaces tend to result in non-uniform encapsulant release, increased diffusion of liquid encapsulants, and increased penetration of oxygen and water which may deleteriously affect sensitive encapsulants, such as readily oxidizable components. Incorporation of a water soluble antioxidant, such as an acidic antioxidant into a dry matrix material may not be effective for preventing oxidation because of the substantial absence of a fluid reaction medium for the antioxidant or immobilization of the antioxidant. Increasing the water content of the matrix material to improve antioxidant mobilization may result in a water activity which is not shelf stable, may adversely affect a desirable crispy texture, or may adversely affect the release properties of the matrix.

The present invention provides a method for incorporating oils containing readily oxidizable polyunsaturated fatty acids such as omega-3 oils into a soft, flexible or pliable fruit matrix or gel which can be used or processed and incorporated into or added to other food products, such as fruit snacks, ready-to eat cereals or cereal bars, snack bars (such as granola bars), health and nutritional bars without breakage to provide edible products with extended shelf life.

### SUMMARY OF THE INVENTION

In a first aspect of the invention a method for preparing a fruit product, containing a polyunsaturated fatty acid, such as an omega-3 fatty acid, comprises cooking a fruit base composition to obtain a cooked fruit base composition, cooling the cooked fruit base composition, and admixing the fruit base composition with an oil comprising at least one readily oxidizable polyunsaturated fatty acid, such as an omega-3 fatty acid. Additionally, the method comprises admixing the cooked fruit base composition with an acidic antioxidant, such as ascorbic acid, for preventing oxidation of the at least one polyunsaturated fatty acid; and at least one polyol, such as glycerin for providing mobility for the acidic antioxidant, to obtain an at least substantially homogeneous mixture, and forming the homogeneous mixture into pieces. The amount of oil may be up to about 25% by weight, for example up to about 15% by weight, preferentially, from about 0.1% by weight to about 15% by weight, based upon the weight of the fruit product, and the admixing may, preferentially, be at a temperature of less than about 180° F. Also, the method may include admixing the fruit base composition with the acidic antioxidant and the polyol to obtain an at least substantially homogeneous mixture, either before, in combination with or after admixing the fruit base composition with the PUFA oil. The acidic antioxidant may be premixed with the polyol to form a solution and the weight ratio of the total amount of acidic antioxidant to the amount of the oil is, preferentially, from about 0.003 to about 1.0.

In additional aspects of the invention, a fruit product containing a polyunsaturated fatty acid is provided and a food product such as a fruit snack, ready-to-eat cereal, or cereal, snack, health or nutritional bars such as a granola bar containing the fruit product is provided. The fruit product may include a heated gellable base composition, such as a cooked fruit base composition, and an oil comprising at least one readily oxidizable polyunsaturated fatty acid, the amount of oil being up to about 25% by weight, for example up to about 15% by weight, preferentially, from about 0.1% by weight to about 15% by weight, based upon the weight of the fruit product. Additionally, the fruit product may contain an acidic antioxidant for preventing oxidation of the at least one polyunsaturated fatty acid; and at least one polyol for providing mobility for the acidic antioxidant, the weight ratio of the total amount of acidic antioxidant to the amount of the oil being from about 0.003 to about 1.0. Also, the fruit product may be in a flexible, gelled form.

In a further aspect of the invention a method for preparing a flexible gel food based composition containing a polyunsaturated fatty acid comprises heating a gellable base composition to obtain a heated gellable base composition, admixing the heated gellable base composition with an oil comprising at least one readily oxidizable polyunsaturated fatty acid. Additionally, the method comprises admixing the heated gellable base composition with an acidic antioxidant for preventing oxidation of the at least one polyunsaturated fatty acid; and optionally at least one polyol for providing mobility for the acidic antioxidant, to obtain an at least substantially homogeneous mixture, and forming the homogeneous mixture into pieces.

### BRIEF DESCRIPTION OF THE DRAWINGS

FIG. 1 shows oxidative stability of fruit samples containing omega-3 oil against a control sample which does not contain omega-3 oil recorded at 90° C. in an Oxipres.

FIG. 2 shows the viscosity of a fruit paste as a function of temperature and shear rate which may be employed in the present invention.

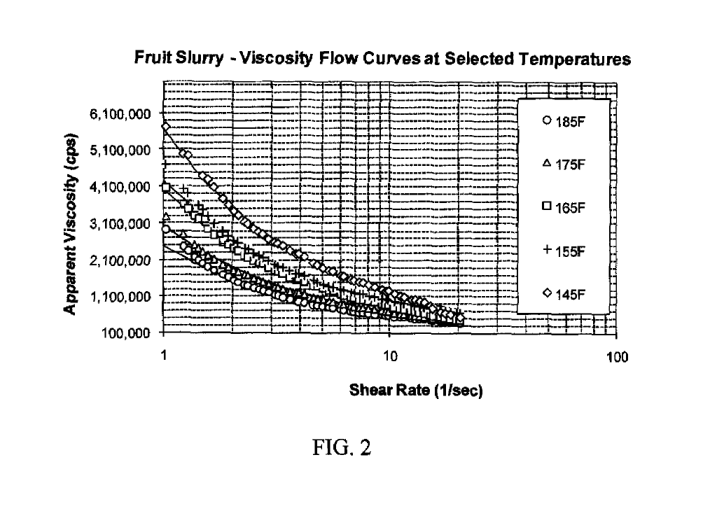

### DETAILED DESCRIPTION OF THE INVENTION

The present invention generally relates to fruit products containing readily oxidizable polyunsaturated fatty acids, and more particularly, to fruit products containing omega-3 fatty acids, and methods for making the fruit products where the free fatty acids such as omega-3 fatty acids are stabilized against oxidation. In embodiments of the invention, a fruit product containing a polyunsaturated fatty acid may be produced by cooking a fruit base composition to obtain a cooked fruit base composition. The cooking of the fruit base composition is generally conducted at a high temperature which would destroy or oxidize the readily oxidizable polyunsaturated acid or cause rancidity in the oil. In the present invention, the cooked fruit base is permitted to cool or is cooled to a temperature which is sufficiently low to avoid any substantial destruction or oxidation of the readily oxidizable polyunsaturated fatty acids upon admixture with the fruit base. However, the temperature is still sufficiently high so as to avoid a substantial increase in viscosity and substantial gelling of the fruit base. In embodiments of the invention, the oil is admixed with the cooked fruit base at a temperature of less than about 180° F., for example from about 150° F. to about 175° F. Exemplary viscosities which may be used range from about 10,000 cps to about 6,000,000 cps, preferably from about 100,000 cps to about 2,000,000 cps.

A premature substantial increase in viscosity and premature substantial gelling of the fruit base would adversely affect mixing of the oil with the fruit base composition so as to achieve a substantially homogeneous mixture, and could also reduce formability of the composition into desirable shapes. Incomplete mixing may also result in oil separation which can lead to excessive surface oil on the fruit product and undesirable oxidation of the unsaturated free fatty acids and rancidity. In addition, in embodiments of the invention, the amount of oil employed may provide a Food & Drug Administration (FDA) minimum recommended daily requirement of polyunsaturated fatty acids such as omega-3 fatty acids. However, the amount of oil employed is not so high so as to cause undesirable oil separation in the fruit product.

Readily oxidizable oils which may be employed in the present invention may comprise, for example, castor oil, algae-based oil or oil derived from algae, flax oil or flax seed oil, fish oil, seed oil, oil from microorganisms, or any other oil containing polyunsaturated fatty acids (PUFA) such as omega-3 fatty acids, eicosapentaenoic acid (EPA), docosahexaenoic acid (DHA), docosapentaenoic acid, and linolenic acid, alpha-linolenic acid, conjugated linolenic acid, gamma linolenic acid, and omega-6 fatty acids. In embodiments of the invention the readily oxidizable oils may be plant oils from plants genetically modified to include a polyunsaturated fatty acid or increased amounts thereof above levels present in oils from non-genetically modified plants, such as soy oil, sunflower oil, canola oil, rapeseed oil, or corn oil. The oils or fruit products may also contain other readily oxidizable oils such as fat soluble vitamins such as vitamins A, D, E, and K, cod liver oil, flavorants, flavor oils, fragrances, active-ingredient containing extracts, e.g. chlorophyll or herbals, phytosterols, agricultural and pharmaceutical and other bioactive components soluble in oil, and mixtures thereof. In embodiments of the invention, the readily oxidizable oil may be any oil derived from any vegetable, animal, marine life, or microorganism which contains a substantial amount, for example at least 5% by weight of a readily oxidizable component. Examples of oils which may contain a substantial amount of a readily oxidizable component are oils derived from soybeans and corn, sunflower oil, rapeseed oil, walnut oil, wheat germ oil, canola oil, krill oil, oil derived from yeast, black currant seed oil, sea buckthorn oil, cranberry seed oil, and grape seed oil. Purified fish oils may, for example, have an omega-3 fatty acid content (DHA, EPA) of from about 25% by weight to about 49% by weight. Flax oil may have an omega-3 fatty acid content as high as about 71% by weight.

In embodiments of the invention, a readily oxidizable oil, such as an omega-3 oil, may be included in an amount of up to about 25% by weight, for example up to about 15% by weight, preferentially from about 0.1 % by weight to about 15% by weight, preferably up to about 10% by weight, for example from about 1% by weight to about 10% by weight, more preferably from about 2.5% by weight to about 7.5% by weight, most preferably up to about 5% by weight, for example from about 2.5% by weight to about 5.0% by weight, based upon the weight of the fruit product.

In embodiments of the invention, the amount or concentration of omega-3 oil in the fruit product which may be needed to meet certain food regulations for various fruit snacks, and fruit in ready-to-eat cereal applications are presented in Table 1 where the calculations are based upon the use of an omega-3 oil containing 30% by weight of omega-3 fatty acids:

TABLE 1
Application and omega-3 oil inclusion to meet food regulations

| | | | | Omega-3 | |
|---|---|---|---|---|---|
| | | | | Fruit | Oil |
| | | | | Product | Load |
| | | Serving | Omega-3 | in Final | in |
| | | Size | Delivery | Product* | Fruit |
| Applications | Threshold | [g] | [mg] | [%] | [%] |
| Fruit based Snacks | min | 10 | 16 | 100 | 0.5 |
| (shapes, sheets, | | 10 | 125 | 100 | 4.2 |
| fruit bars, | max | 25 | 16 | 100 | 0.2 |
| particulates etc.) | | 25 | 125 | 100 | 1.7 |
| RTE Breakfast | min | 30 | 16 | 10 | 1.8 |
| Cereals and grain- | | 30 | 125 | 10 | 13.9 |
| based snacks | max | 55 | 16 | 10 | 1.0 |
| | | 55 | 125 | 10 | 7.6 |
| | min | 30 | 16 | 20 | 0.9 |
| | | 30 | 125 | 20 | 6.9 |
| | max | 55 | 16 | 20 | 0.5 |
| | | 55 | 125 | 20 | 3.8 |

*Numbers indicate the percentage of omega-3 fruit product in the final product, e.g. 10% fruit pieces in cereal.

Additionally, the method of the present invention comprises admixing a heated gellable food base composition, such as a cooked fruit base composition, with an acidic antioxidant for preventing oxidation of the at least one polyunsaturated fatty acid, and at least one polyol for providing mobility for the acidic antioxidant, to obtain an at least substantially homogeneous mixture, and forming the homogeneous mixture into pieces. The polyol may be a liquid polyol such as glycerol, or a solid or crystalline polyol such as crystalline sorbitol. The solid or crystalline polyol may be dissolved in the gellable food base composition, such as a cooked fruit base composition, or may be dissolved in water to obtain a liquid polyol. In embodiments of the invention the acidic antioxidant and/or the liquid or solid or crystalline polyol may be added during production of the base composition, prior to, and/or during heating or cooking of the base composition. For example, in embodiments of the invention the acidic antioxidant and/or the liquid or crystalline polyol may be admixed with the fruit base before the fruit base is heated or cooked.

An acidic antioxidant for prevention of oxidation of the active, sensitive encapsulant is dispersed throughout the fruit base composition, and fruit gel or fruit matrix material. The polyol provides mobility to the antioxidant throughout the fruit gel or fruit matrix material. The acidic antioxidant neutralizes and helps to prevent escape of malodorous basic compounds, such as amines from the fruit product.

In embodiments, the acidic antioxidant may be added to the fruit base composition, to a polyol that is mixed with the fruit base composition, or combinations thereof. Generally, the fruit base composition may be formulated with an acidic antioxidant, and additional acidic antioxidant is admixed with the cooked fruit base composition. Preferably, the additional acidic antioxidant is premixed with the polyol to form a solution of the acidic antioxidant in the polyol, and then the acidic antioxidant/polyol solution is admixed with the oil-containing fruit base composition to obtain a substantially homogeneous mixture.

Exemplary acidic antioxidants or proton-donating antioxidants which may be employed in effective amounts in the fruit base composition are organic acids such as L-cysteine, acetic acid, tartaric acid, lactic acid, malic acid, citric acid, fumaric acid, propionic acid, tannic acid, ascorbic acid, iso-ascorbic acid, and erythorbic acid, tocopherol, catechin, salts thereof, isomers thereof, derivatives thereof, and mixtures thereof. Exemplary salts which may be employed are alkaline earth metal and alkali metal salts, such as calcium, potassium, and sodium salts of ascorbic acid, erythorbic acid, and L-cysteine, and phenolic salts. Exemplary derivatives include acid anhydrates, esters, amides, and lipophilic acids. The preferred acidic antioxidants for use in the matrix material are organic acids such as citric acid, ascorbic acid and erythorbic acid, most preferably ascorbic acid.

The total amount of the acidic antioxidant, from all sources including from the fruit base composition and from the amount added to the fruit base composition, or the amount added by the antioxidant solution may be from about 0.003% by weight to about 9% by weight, preferably from about 0.5% by weight to about 6% by weight, most preferably from about 1.5% by weight to about 3% by weight, based upon the weight of the fruit product. In embodiments of the invention, the weight ratio of the total amount of acidic antioxidant to the amount of polyunsaturated fatty acid oil, such as omega-3 fatty acid oil, may be from about 0.003 to about 1.0. Ascorbic acid concentrations as a function of oil concentration and the ascorbic acid/oil ratio which may be employed in embodiments of the present invention are presented in Table 2:

TABLE 2
Ascorbic acid concentration as a function of oil concentration and
the ascorbic acid/oil ratio.

| | | Ascorbic Acid/Omega-3 Oil Ratio | | | | | | |
|---|---|---|---|---|---|---|---|---|
| | | 0.003 | 0.1 | 0.2 | 0.3 | 0.4 | 0.5 | 0.6 |
| Oil | 1 | 0.003 | 0.1 | 0.2 | 0.3 | 0.4 | 0.5 | 0.6 |
| Conc. | 5 | 0.015 | 0.5 | 1.0 | 1.5 | 2.0 | 2.5 | 3.0 |
| | 10 | 0.030 | 1.0 | 2.0 | 3.0 | 4.0 | 5.0 | 6.0 |
| | 15 | 0.045 | 1.5 | 3.0 | 4.5 | 6.0 | 7.5 | 9.0 |

The polyol or combination of polyols for dispersing and mobilizing the acidic antioxidant throughout the fruit gel or fruit matrix material may be employed in an amount which solubilizes the acidic antioxidant and is retained in the gelled product in a sufficient amount to prevent substantial crystallization of the acidic antioxidant, and provide mobility to the acidic antioxidant in the gelled fruit product or gelled fruit matrix. It is assumed that the mobility provided should be such so that the acidic antioxidant can react with any ambient oxygen which enters the fruit product interior or fruit matrix material to prevent the oxygen from reacting with the oil or polyunsaturated fatty acids. Also, the polyol should keep the acid antioxidant solubilized and prevent substantial crystallization in the gelled fruit product. The mobility should enable the acidic antioxidant to donate protons to terminate any radicals from the fatty acids and/or react with any malodorous amines given off by fish oils. Exemplary of mobilizing polyols or glycols which may be employed with the acidic antioxidant are glycerol, propylene glycol, polyethylene glycol, and sugar alcohols such as sorbitol. The polyol may be a liquid polyol such as glycerol or a solid or crystalline polyol such as sorbitol which forms a solution with water or dissolves in the gellable food base composition such as a cooked fruit base composition. Glycerol is the preferred polyol or mobilizing agent for admixing with the acidic antioxidant.

In embodiments of the invention, water may also be employed with the polyol to solubilize the acidic antioxidant, however, large amounts of water may slow gelling or increase the water activity of the fruit product.

The amount of the polyol, such as glycerol, should be sufficient to solubilize or suspend the antioxidant or most of the antioxidant and/or keep it mobile and reactive. Exemplary amounts of the polyol may range from about 50% by weight to about 85% by weight, based upon the total weight of the polyol and the acidic antioxidant. In embodiments of the invention, heating and stirring may be employed to solubilize the antioxidant. Exemplary heating temperatures for solubilizing the polyol may be up to about 80° C.

In embodiments of the invention, fruit products may optionally include an emulsifier in an effective emulsifying amount to aid in the avoidance of oil separation. Conventional emulsifiers used in food and pharmaceutical products, such as mono-glycerides and di-glycerides, may be selected for use according to the present invention.

The fruit base composition employed in the present invention may be any known fruit base, made by known processes, using any conventional ingredients or materials for making gummy candies, jelly candies, and fruit snacks. For example, the fruit base composition may include one or more of fruit juices, fruit concentrates, and fruit purees, one or more artificial and/or natural fruit flavors, one or more sweeteners such as high fructose corn syrup, corn syrup, sugars such as sucrose and dextrose, maltitol syrup, corn syrup solids, maltodextrins, and sorbitol, one or more synthetic, artificial or non-nutritive sweeteners, one or more edible acids such as citric acid, malic acid, and ascorbic acid, one or more edible buffering agents such as sodium citrate or potassium citrate, coloring, flavoring, a dairy component, such as cream or milk, preservatives, and nutrients such as vitamins and minerals. The gellable fruit base composition or component may contain one or more gelling agents such as pectin, gelatin, carrageenan, agar, modified food starches, such as modified corn starch, xanthan gum, and other gums and hydrocolloids. In embodiments of the invention, a high methoxypectin which sets up in the presence of acid may be employed as a gelling agent.

In embodiments of the present invention, the gellable fruit base composition or component may contain from 0% by weight to about 80% by weight, generally from about 5% by weight to about 40% by weight of one or more corn syrups, from about 0% by weight to about 45% by weight, preferably from about 10% by weight to about 25% by weight sucrose, from about 0% by weight to about 80% by weight other sweeteners such as dextrose, corn syrup solids, maltitol syrup, sorbitol, and maltodextrin, about 0.01% by weight to about 12% by weight, preferably from about 0.5% by weight to about 10% by weight, of at least one gelling agent such as pectin, gelatin, carrageenan, agar, modified starch, such as modified corn starch, and other gums and hydrocolloids, from about 0% by weight to about 20% by weight, preferably from about 2% by weight to about 12% by weight of a fruit component such as at least one fruit puree, fruit juice concentrate, and fruit juice, about 0.01% by weight to about 5% by weight, preferably from about 0.5% by weight to about 2.5% by weight of at least one buffering agent such as sodium citrate, and potassium citrate, from about 0.01% by weight to about 5% by weight, preferably from about 0.5% by weight to about 3% by weight of at least one acidic agent such as citric acid, malic acid, and ascorbic acid, from about 0% by weight to about 5% by weight, preferably from about 0% by weight to about 2% by weight of at least one coloring agent or color, about 0.01% by weight to about 5% by weight, preferably from about 0.1% by weight to about 2% by weight of a flavoring agent or flavor, about 0% by weight to about 6% by weight of a dairy component such as cream, about 0% by weight to about 5% by weight, preferably from about 0.01% by weight to about 1% by weight of at least one vitamin, such as vitamin C, and effective sweetening amounts of any optional one or more synthetic, artificial or non-nutritive sweeteners, where the percentages are based upon the total weight of the individual components or fruit base composition or component, and add up to 100% by weight.

Fruit materials, such as fruit purees, fruit juices, and fruit concentrates from any fruit may be used herein. Examples of such fruits useful herein include apricot, pineapple, lemon, orange, peach, pear, lime, banana, grape, mango, apple, tomato, blackberry, plum, watermelon, blueberry, raspberry, strawberry, current, cherry, cranberry, and mixtures thereof. In embodiments of the invention, one or more natural fruit flavors, artificial fruit flavors, and mixtures thereof may be employed in effective flavoring amounts.

The fruit base composition may be emulsified or non-emulsified, and may be formulated to contain only natural ingredients. The buffering agent helps to prevent premature gelling or pre-gelling of the gelling agent of the components prior to forming. In embodiments which contain a vitamin, use of a buffering helps to retard vitamin degradation.

In embodiments of the invention, flexible gelled food products which may or may not contain fruit may be produced without the need for cooking a gellable food base composition. Cold-setting hydrocolloids which may be employed to obtain gelled products include gellable hydrocolloids such as cellulose based hydrocolloids such as methylcellulose, hydroxymethylcellulose, and hydroxypropylmethylcellulose, pectin, modified starches, and mixtures thereof. In exemplary embodiments, the ingredients may, if needed, be heated to a temperature sufficient to dissolve and mix the ingredients, and obtain a flowable mixture which may be formed. For example, in embodiments of the invention, a flexible gel food based composition containing a polyunsaturated fatty acid may be produced by heating a gellable composition to obtain a heated gel base composition; admixing the gel base composition with an oil comprising at least one readily oxidizable polyunsaturated fatty acid, an acidic antioxidant for preventing oxidation of said at least one polyunsaturated fatty acid; and at least one polyol for providing mobility for said acidic antioxidant to obtain an at least substantially homogeneous mixture, and forming the homogeneous mixture into pieces. In other embodiments of the invention, a flexible gel food based composition containing a polyunsaturated fatty acid may be produced by admixing a gellable composition with an oil comprising at least one readily oxidizable polyunsaturated fatty acid, an acidic antioxidant for preventing oxidation of said at least one polyunsaturated fatty acid; and at least one polyol for providing mobility for said acidic antioxidant to obtain an at least substantially homogeneous mixture at temperatures which dissolve the ingredients, and allows adequate mixing to form a substantially homogeneous mixture without substantial destruction or oxidation of the at least one readily oxidizable polyunsaturated fatty acid, and forming the homogeneous mixture into pieces. Exemplary temperatures which may be employed may range from about room temperature up to about 180° F., preferably up to about 140° F.

The water activity for the fruit base composition and fruit product is preferably less than about 0.7 to assure microbial shelf stability. In embodiments of the present invention, the solids content of the fruit base composition or component may range from about 40% by weight to about 80% by weight, for example from about 50% by weight to about 60% by weight. The pH of the products of the present invention may range from about 2 to about 7, preferably less than about 4.6, for example from about 3.5 to about 4.6 to ensure microbial stability.

Generally, the fruit base composition may be produced by admixing water, at least one gelling agent, such as pectin, at least one sugar or sweetening agent, such as sucrose, dextrose and corn syrup, fruit puree or concentrate, and a buffering agent such as sodium citrate to obtain a substantially homogenous slurry. The resulting slurry may be cooked to obtain a cooked base slurry. The cooked base slurry may be admixed with a gel setting agent, such as citric acid. An additional gelling agent, such as gelatin may be admixed with the cooked base slurry to slow the gelling or setting rate of the fruit base composition or component. In addition, the remaining ingredients such as color, flavor, and dairy ingredients may be admixed with the cooked base slurry prior admixing with the oil.

Cooking temperatures may range, generally from about 200° F. to about 300° F., depending upon the gelling agent. In some embodiments, the base slurry may be cooked to a temperature of about 265° F. to about 280° F. using a continuous cooker and then subjected to vacuum flashing to reduce the temperature to about 180° F. to about 205° F.

In embodiments of the invention, well-known starch mold casting techniques can be used to practice the piece-forming step. Starch molding is often referred to in the trade as the Mogul system. Generally, the starch mold casting process involves the steps of forming a gellable slurry into pieces such as depositing into a multiplicity of starch cavity molds or depressions or suitable shape and size formed into starch beds. At the beginning of this step, the gellable slurry is in the form of a viscous but fluid or plastic mass so that the compositions can take the shape of the mold even if complexly shaped. If, however, the slurry is too viscous or is allowed to cool to below the gellation temperature of the gelling agent, then the shapes taken can be defective.

The fruit products of the present invention may be produced in various physical forms and shapes such as: 1) in rolled sheet form; 2) in rolled strip form; 3) in string or rope form, unmounted or mounted on a U-board; 4) soft center filled pieces, and 5) in gelled bite size pieces of various shapes or in gelled bite size piece form prepared by starch molding, all using known forming techniques.

Fruit products of the present invention are durable during material handling processes employed after deposition and molding such as oiling, polishing, and packaging. The fruit products may be produced in a wide variety of shapes, such as spherical or toy marble shaped, fruit shapes, gum drop shapes, jelly bean shapes, animal, fish, or plant shapes, and the like. The products may exhibit long term shelf life in bags or pouches of at least about one year without substantial oxidation of the readily oxidizable polyunsaturated fatty acids, such as omega-3 fatty acids.

In embodiments of the invention, a ready-to-eat cereal containing a shelf stable fruit product with omega-3 oil may be produced by extruding a substantially homogeneous fruit mixture, cutting the rope into pieces, or molding the fruit mixture into pieces, such as raisin-like pieces, and admixing the pieces with a ready-to-eat cereal, such as cereal flakes, puffed cereals, extruded cereals, and shredded cereals.

The following examples, wherein all parts, percentages, and ratios are by weight, all temperatures are in ° F., and all pressures are atmospheric pressure unless indicated to the contrary, illustrate the present invention:

### EXAMPLE 1

This example demonstrates the stabilizing effect of a glycerin/acid solution on omega-3 oils incorporated in fruit snacks. The ingredients and their relative amounts which may be used to produce: a) a control fruit product which does not have any omega-3 oil, b) fruit products which contain omega-3 oil but do not contain added glycerin/ascorbic acid, and c) fruit products which contain omega-3 oil and added glycerin/ascorbic acid in accordance with the present invention are shown in Table 3:

TABLE 3
Formulas and acid balance for the control and variations V1 to V9 of Example 1
Experimental Design, Part 1

| | Variation | | | | | | | | | |
|---|---|---|---|---|---|---|---|---|---|---|
| | Control | | 1 | | 2 | | 3 | | 4 | |
| Glycerin/Acid [%] | 0 | | 0 | | 0 | | 0 | | 2.5 | |
| Oil Load [%] | 0 | | 2.5 | | 5 | | 7.5 | | 2.5 | |
| | [g] | [%] | [g] | [%] | [g] | [%] | [g] | [%] | [g] | [%] |
| Formulas | | | | | | | | | | |
| Fruit Base [g] | 1500.0 | 100.0 | 1500.0 | 97.5 | 1500.0 | 95.0 | 1500.0 | 92.5 | 1500.0 | 95.0 |
| Glycerin/Acid Solution [g] | 0.0 | 0.0 | 0.0 | 0.0 | 0.0 | 0.0 | 0.0 | 0.0 | 39.5 | 2.5 |
| Unencap Omega-3 Oil [g] | 0.0 | 0.0 | 38.5 | 2.5 | 78.9 | 5.0 | 121.6 | 7.5 | 39.5 | 2.5 |
| Product Total [g] | 1500.0 | 100.0 | 1538.5 | 100.0 | 1578.9 | 100.0 | 1621.6 | 100.0 | 1578.9 | 100.0 |
| Acid Balance | | | | | | | | | | |
| Acid in Fruit Base | 20.3 | 1.36 | 20.3 | 1.36 | 20.3 | 1.36 | 20.3 | 1.36 | 20.3 | 1.36 |
| Acid in Glycerin/Acid Solution | 0.0 | 0.00 | 0.0 | 0.00 | 0.0 | 0.00 | 0.0 | 0.00 | 10.7 | 27.20 |
| Acid in Total Product^{#} | 20.3 | 1.36 | 20.3 | 1.32 | 20.3 | 1.29 | 20.3 | 1.25 | 31.1 | 1.97 |
| Ascorbic Acid in Fruit Base | 0.9 | 0.06 | 0.9 | 0.06 | 0.9 | 0.06 | 0.9 | 0.06 | 0.9 | 0.06 |
| Ascorbic Acid in Gly/Acid Solution | 0.0 | 0.00 | 0.0 | 0.00 | 0.0 | 0.00 | 0.0 | 0.00 | 10.7 | 27.20 |
| Ascorbic Acid in Total Product^{##} | 0.9 | 0.06 | 0.9 | 0.06 | 0.9 | 0.06 | 0.9 | 0.06 | 11.6 | 0.74 |

Experimental Design, Part 2

| | Variation | | | | | | | | | |
|---|---|---|---|---|---|---|---|---|---|---|
| | 5 | | 6 | | 7 | | 8 | | 9 | |
| Glycerin/Acid [%] | 2.5 | | 2.5 | | 5 | | 5 | | 5 | |
| Oil Load [%] | 5 | | 7.5 | | 2.5 | | 5 | | 7.5 | |
| | [g] | [%] | [g] | [%] | [g] | [%] | [g] | [%] | [g] | [%] |
| Formulas | | | | | | | | | | |
| Fruit Base [g] | 1500.0 | 92.5 | 1500.0 | 90.0 | 1500.0 | 92.5 | 1500.0 | 90.0 | 1500.0 | 87.5 |
| Glycerin/Acid Solution [g] | 40.5 | 2.5 | 41.7 | 2.5 | 81.1 | 5.0 | 83.3 | 5.0 | 85.7 | 5.0 |
| Unencap Omega-3 Oil [g] | 81.1 | 5.0 | 125.0 | 7.5 | 40.5 | 2.5 | 83.3 | 5.0 | 128.6 | 7.5 |
| Product Total [g] | 1621.6 | 100.0 | 1666.7 | 100.0 | 1621.6 | 100.0 | 1666.7 | 100.0 | 1714.3 | 100.0 |
| Acid Balance | | | | | | | | | | |
| Acid in Fruit Base | 20.3 | 1.36 | 20.3 | 1.36 | 20.3 | 1.36 | 20.3 | 1.36 | 20.3 | 1.36 |
| Acid in Glycerin/Acid Solution | 11.0 | 27.20 | 11.3 | 27.20 | 22.1 | 27.20 | 22.7 | 27.20 | 23.3 | 27.20 |
| Acid in Total Product^{#} | 31.4 | 1.93 | 31.7 | 1.90 | 42.4 | 2.61 | 43.0 | 2.58 | 43.7 | 2.55 |
| Ascorbic Acid in Fruit Base | 0.9 | 0.06 | 0.9 | 0.06 | 0.9 | 0.06 | 0.9 | 0.06 | 0.9 | 0.06 |
| Ascorbic Acid in Gly/Acid Solution | 11.0 | 27.20 | 11.3 | 27.20 | 22.1 | 27.20 | 22.7 | 27.20 | 23.3 | 27.20 |
| Ascorbic Acid in Total Product^{##} | 11.9 | 0.74 | 12.2 | 0.73 | 23.0 | 1.42 | 23.6 | 1.41 | 24.2 | 1.41 |

^{#}Total acid represented by all acids and acid salts incl. citric acid, sodium citrate, malic acid, potassium citrate, ascorbic acid, sodium ascorbate
^{##}Total ascorbic acid represented by ascorbic acid and its salt sodium ascorbate

The fruit base composition employed is a conventional formulation which includes sugar, fruit concentrate, corn syrup, modified corn starch, shortening, maltodextrin, cottonseed oil, carrageenan, citric acid, monoglycerides sodium citrate, malic acid, potassium citrate, ascorbic acid, and an xanthan gum sugar blend. The unencapsulated omega-3 oil source is a fish oil produced by Denomega Nutritional Oils, Sarpsborg, Norway.

The glycerin/acid solution employed may be produced by dissolving the ascorbic acid and sodium ascorbate in a mixture of glycerin and water with stirring and heating at about 60° C. to obtain a clear solution where the antioxidant does not recrystallize out even if left overnight at room temperature. The composition of the glycerin/acid solution employed, where all percentages are by weight [%] is shown in Table 4:

TABLE 4
Glycerin/Acid Solution Composition

| | |
|---|---|
| Glycerin | 58.2% |
| Water | 14.6% |
| Ascorbic Acid | 11.7% |
| Sodium Ascorbate | 15.5% |
| TOTAL | 100.0% |

The omega-3 fruit samples may be prepared by the following procedure:
1. The fruit base may be prepared by mixing all ingredients from the fruit base ingredient list in a kettle at 120° F. to 140° F. with the gums being added shortly before transferring the fruit mass over to a drum dryer.
2. The fruit mass may be heated and cooked using a drum dryer; with the temperature of the drums being about 300° F.
3. A fruit base at a temperature of about 180° F. may be obtained after the drum drying process.
4. Appropriate amounts of fruit base, omega 3 oil, and glycerin/acid solution are then weighed for each variation or formulation as set forth in Table 1.
5. The ingredients may be blended using a Hobart stand mixer with a flat beater attachment.
6. First, the hot fruit base may be added to the mixing bowl and the mixer may be started on low speed.
7. With the temperature of the fruit mass now being lower than approximately 170° F. the omega 3 oil may be poured into the mixer.
8. Next the glycerin/acid solution may be slowly poured into the mixer.
9. Mixing at low speed for about 1.5 minutes, then mixing at medium speed for about 0.5 minute may then be performed.
10. The mixture may then be poured between two sheets of plastic film and then rolled with a rolling pin to less than about 5 mm thickness.
11. The sample may then be allowed to cool to room temperature.

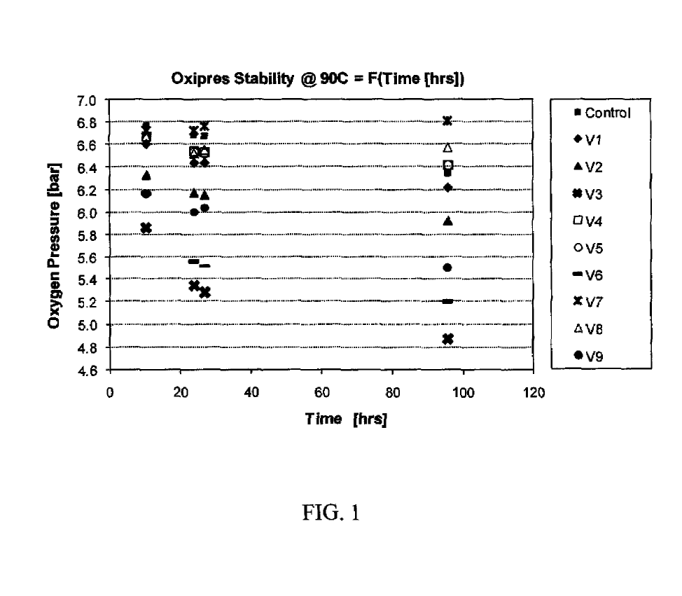

Each of the control and the omega-3 containing fruit samples were subjected to an Oxipres stability test in oxygen flushed, stainless steel canisters to determine the oxidative stability of the omega-3 fruit samples at 90° C. and an initial canister pressure of about 5 bars, and the results are shown in FIG. 1 and Table 5:

TABLE 5
Oxidative stability of omega-3 fruit samples recorded at 90° C.
in Oxipres against control sample.

| | Factor A | Factor | Ascorbic | | | | |
|---|---|---|---|---|---|---|---|
| | Glycerin/ | B Oil | Acid/ | Oxipres Stability | | | |
| | Acid | load | Omega-3 | (90° C.) = F(Time [hrs]) | | | |
| Variation | Conc. [%] | [%] | Oil Ratio | 10.5 | 24 | 27 | 96 |
| Control | 0 | 0 | — | 6.77 | 6.69 | 6.68 | 6.35 |
| V1 | 0 | 2.5 | 0.023 | 6.61 | 6.44 | 6.44 | 6.22 |
| V2 | 0 | 5 | 0.011 | 6.33 | 6.17 | 6.15 | 5.92 |
| V3 | 0 | 7.5 | 0.007 | 5.86 | 5.34 | 5.28 | 4.87 |
| V4 | 2.5 | 2.5 | 0.295 | 6.67 | 6.54 | 6.53 | 6.42 |
| V5 | 2.5 | 5 | 0.147 | 6.65 | 6.53 | 6.52 | 6.42 |
| V6 | 2.5 | 7.5 | 0.098 | 6.17 | 5.56 | 5.52 | 5.20 |
| V7 | 5 | 2.5 | 0.566 | 6.72 | 6.72 | 6.76 | 6.81 |
| V8 | 5 | 5 | 0.283 | 6.67 | 6.52 | 6.55 | 6.57 |
| V9 | 5 | 7.5 | 0.188 | 6.17 | 6.00 | 6.04 | 5.50 |

Variations V4, V5, V7, and V8 highlighted are samples that are more stable after 96 hours in the Oxipres than the control without any omega-3 oil

A pressure drop in the Oxipres is a measure of the degree for oxygen consumption and hence ongoing oxidation; where no pressure drop indicates no oxidation. As shown in Table 5 and FIG. 1, the oxidative stability of a fruit snack significantly depends on the amount of incorporated omega-3 oil, but also on the acid/glycerin concentration. The samples with no additional glycerin/acid and the highest oil concentration (V3) was the least stable. The sample with the highest concentration of glycerin/acid and the smallest oil loading (V7) was the most stable. Samples with no additional glycerin/acid (V1, V2, V3) were less stable than the control. The least stable products are those with 7.5% oil inclusion which in part was caused by free surface oil, oil that was not efficiently incorporated and/or absorbed by the fruit matrix. At levels of 2.5% and 5% glycerin/acid concentration the products with 2.5% and 5% oil inclusion were even more stable than the control sample after 96 hours at 90° C. in the Oxipres. Hence, the addition of glycerin/acid provides a significant stabilizing effect for omega-3 oil in fruit matrices.

### EXAMPLE 2

A shelf stable fruit snack containing omega-3 oil may be produced by pouring a substantially homogeneous fruit mixture as obtained in Example 1, sample V7 into a starch mold and permitting the mixture to set.

### EXAMPLE 3

A shelf stable fruit snack containing omega-3 oil may be produced by extruding a substantially homogeneous fruit mixture as obtained in Example 1, sample V7 into an elongated strip, permitting the strip to set, and rolling the strip into a roll.

### EXAMPLE 4

A ready-to-eat cereal containing a shelf stable fruit product with omega-3 oil may be produced by extruding a substantially homogeneous fruit mixture as obtained in Example 1, sample V7 into a rope, cutting the rope into pieces, and admixing the pieces with a ready-to-eat cereal.

### EXAMPLE 5

Shelf stable fruit pieces containing omega-3 oil may be produced by cutting an extruded substantially homogeneous fruit mixture as obtained in Example 1, sample V7, and the cut pieces may be incorporated into a cereal grain containing snack bar, such as a granola bar.

What is claimed is:

1. A method for preparing a fruit product containing a polyunsaturated fatty acid comprising:
a) cooking a fruit base composition to obtain a cooked fruit base composition;
b) cooling the cooked fruit base composition; and
c) admixing the fruit base composition with an oil comprising at least one readily oxidizable polyunsaturated fatty acid, an acidic antioxidant for preventing oxidation of said at least one polyunsaturated fatty acid;
and at least one polyol for providing mobility for said acidic antioxidant to obtain an at least substantially homogeneous mixture.

2. A method as claimed in claim I wherein the oil comprises omega-3 fatty acids.

3. A method as claimed in claim 1 wherein the oil is admixed with the cooked fruit base composition prior to admixing the acidic antioxidant and the polyol with the cooked fruit base composition.

4. A method as claimed in claim 1 wherein the acidic antioxidant and the at least one polyol are premixed to form an antioxidant solution, and the antioxidant solution is admixed with the fruit base composition.

5. A method as claimed in claim 3 wherein the acidic antioxidant and the at least one polyol are premixed to form an antioxidant solution, and the antioxidant solution is admixed with the fruit base composition.

6. A method as claimed in claim 1 wherein the oil is admixed with the cooked fruit base at a temperature of less than about 180° F.

7. A method as claimed in claim 6 wherein the oil is admixed with the cooked fruit base at a temperature of from about 150° F. to about 175° F.

8. A method as claimed in claim 1 wherein the amount of said oil is up to about 25% by weight, based upon the weight of the fruit product.

9. A method as claimed in claim I wherein the amount of said oil is up to about 15% by weight, based upon the weight of the fruit product.

10. A method as claimed in claim 1 wherein the amount of said oil is up to about 10% by weight, based upon the weight of the fruit product.

11. A method as claimed in claim 1 wherein the amount of said oil is from about 2.5% by weight to about 7.5% by weight, based upon the weight of the fruit product.

12. A method as claimed in claim 1 wherein the weight ratio of the total amount of acidic antioxidant to the amount of said oil is from about 0.003 to about 1.0.

13. A method as claimed in claim 1 wherein the total amount of acidic antioxidant is from about 0.5% by weight to about 6% by weight, based upon the weight of the fruit product.

14. A method as claimed in claim 1 wherein the total amount of acidic antioxidant is from about 1.5% by weight to about 3% by weight, based upon the weight of the fruit product.

15. A method as claimed in claim 8 wherein the total amount of acidic antioxidant is from about 0.003% by weight to about 9% by weight, based upon the weight of the fruit product.

16. A method as claimed in claim 11 wherein the total amount of acidic antioxidant is from about 1.5% by weight to about 3% by weight, based upon the weight of the fruit product.

17. A method as claimed in claim 1 wherein the amount of said polyol is from about 50% by weight to about 85% by weight, based upon the total weight of the polyol and the acidic antioxidant.

18. A method as claimed in claim 1 wherein said acidic antioxidant comprises at least one member selected from the group consisting of citric acid, ascorbic acid, erythorbic acid, and salts thereof.

19. A method as claimed in claim 1 wherein said polyol comprises at least one member selected from the group consisting of glycerol, propylene glycol, and sorbitol.

20. A method as claimed in claim 1 wherein said oil comprises at least one member selected from the group consisting of fish oil, flax seed oil, oil derived from algae, and plant oils from plants genetically modified to include a polyunsaturated fatty acid.

21. A method as claimed in claim 1 wherein the homogeneous mixture is formed into pieces or shapes.

22. A method for preparing a fruit product containing a polyunsaturated fatty acid comprising:
a) cooking a fruit base composition to obtain a cooked fruit base composition;
b) cooling the cooked fruit base composition;
c) admixing the fruit base composition with an oil comprising omega-3 fatty acids, the amount of oil being from about 0.1% by weight to about 15% by weight, based upon the weight of the fruit product, said admixing being at a temperature of less than about 180° F., and
d) admixing the fruit base composition with an acidic antioxidant comprising ascorbic acid for preventing oxidation of said omega-3 fatty acids, and glycerin to obtain an at least substantially homogeneous mixture, the weight ratio of the total amount of acidic antioxidant to the amount of said oil being from about 0.003 to about 1.0.

23. A method as claimed in claim 22 wherein the homogeneous mixture is extruded into strips or molded in a starch mold.

24. A flexible gelled food product containing a polyunsaturated fatty acid comprising:
a) a gelled food composition;
b) an oil comprising at least one readily oxidizable polyunsaturated fatty acid, and
c) an acidic antioxidant for preventing oxidation of said at least one polyunsaturated fatty acid; and at least one polyol for providing mobility for said acidic antioxidant, the weight ratio of the total amount of acidic antioxidant to the amount of said oil being from about 0.003 to about 1.0.

25. A flexible gelled food product as claimed in claim 24 wherein said gelled food composition comprises a hydrocolloid.

26. A flexible gelled food product as claimed in claim 24 wherein said gelled food composition comprises a methylcelluolose gel, an hydroxymethylcellulose gel, an hydroxypropylmethylcellulose gel, a pectin, a modified starch gel, or mixtures thereof.

27. A fruit product containing a polyunsaturated fatty acid comprising:
a) a cooked fruit base composition;
b) an oil comprising at least one readily oxidizable polyunsaturated fatty acid, and
c) an acidic antioxidant for preventing oxidation of said at least one polyunsaturated fatty acid; and at least one polyol for providing mobility for said acidic antioxidant, the weight ratio of the total amount of acidic antioxidant to the amount of said oil being from about 0.003 to about 1.0;
wherein said fruit product is in a flexible, gelled form.

28. A fruit product as claimed in claim 27 wherein said at least one readily oxidizable polyunsaturated fatty acid comprises an omega-3 fatty acid, said acidic antioxidant comprises at least one member selected from the group consisting of citric acid, ascorbic acid, erythorbic acid, and salts thereof, said polyol comprises at least one member selected from the group consisting of glycerol, propylene glycol, and sorbitol, the amount of said oil is from about 0.1% by weight to about 15% by weight, based upon the weight of the fruit product, and the total amount of acidic antioxidant is from about 0.5% by weight to about 6% by weight, based upon the weight of the fruit product.

29. A food product as claimed in claim 28 which is in the form of a strip or molded piece.

30. A ready-to-eat cereal comprising a fruit product as claimed in claim 27.

31. A fruit snack comprising a fruit product as claimed in claim 27.

32. A cereal, snack, health or nutritional bar product comprising a fruit product as claimed in claim 27.

33. A method for preparing a flexible gelled food product containing a polyunsaturated fatty acid comprising admixing a gellable composition with an oil comprising at least one readily oxidizable polyunsaturated fatty acid, an acidic antioxidant for preventing oxidation of said at least one polyunsaturated fatty acid; and at least one polyol for providing mobility for said acidic antioxidant to obtain an at least substantially homogeneous mixture.

34. A method as claimed in claim 33 wherein said gellable composition comprises a hydrocolloid.

35. A method as claimed in claim 33 wherein said gellable composition comprises a methylcelluolose gel, an hydroxymethylcellulose gel, an hydroxypropylmethylcellulose gel, a pectin, a modified starch gel, or mixtures thereof.

36. A method as claimed in claim 33 where the oil comprises omega-3 fatty acids.

37. A method as claimed in claim 33 where the gellable composition is heated to obtain a heated gel base composition, and the gel base composition is admixed with the oil.

38. A method as claimed in claim 37 wherein the acidic antioxidant and the at least one polyol are premixed to form an antioxidant solution, and the antioxidant solution is admixed with the gel base composition.

39. A method as claimed in claim 37 wherein the oil is admixed with the gel base composition at a temperature of less than about 180° F.

40. A method as claimed in claim 37 wherein the oil is admixed with the gel base composition at a temperature of from about 150° F. to about 175° F.

41. A method as claimed in claim 37 wherein the oil is admixed with the gel base composition at a temperature of up to about 140° F.

42. A method as claimed in claim 33 wherein the amount of said oil is up to about 25% by weight, based upon the weight of the flexible gelled food product.

43. A method as claimed in claim 33 wherein the amount of said oil is up to about 15% by weight, based upon the weight of the flexible gelled food product.

44. A method as claimed in claim 33 wherein the amount of said oil is up to about 10% by weight, based upon the weight of the flexible gelled food product.

45. A method as claimed in claim 33 wherein the amount of said oil is from about 2.5% by weight to about 7.5% by weight, based upon the weight of the flexible gelled food product.

46. A method as claimed in claim 33 wherein the weight ratio of the total amount of acidic antioxidant to the amount of said oil is from about 0.003 to about 1.0.

47. A method as claimed in claim 33 wherein the total amount of acidic antioxidant is from about 0.5% by weight to about 6% by weight, based upon the weight of the flexible gelled food product.

48. A method as claimed in claim 33 wherein the total amount of acidic antioxidant is from about 1.5% by weight to about 3% by weight, based upon the weight of the flexible gelled food product.

49. A method as claimed in claim 43 wherein the total amount of acidic antioxidant is from about 0.003% by weight to about 9% by weight, based upon the weight of the flexible gelled food product.

50. A method as claimed in claim 45 wherein the total amount of acidic antioxidant is from about 1.5% by weight to about 3% by weight, based upon the weight of the flexible gelled food product.

51. A method as claimed in claim 33 wherein the amount of said polyol is from about 50% by weight to about 85% by weight, based upon the total weight of the polyol and the acidic antioxidant.

52. A method as claimed in claim 33 wherein said acidic antioxidant comprises at least one member selected from the group consisting of citric acid, ascorbic acid, erythorbic acid, and salts thereof.

53. A method as claimed in claim 33 wherein said polyol comprises at least one member selected from the group consisting of glycerol, propylene glycol, and sorbitol.

54. A method as claimed in claim 33 wherein said oil comprises at least one member selected from the group consisting of fish oil, flax seed oil, oil derived from algae, and plant oils from plants genetically modified to include a polyunsaturated fatty acid.

55. A method as claimed in claim 33 wherein the homogeneous mixture is formed into pieces or shapes.

56. A method as claimed in claim 33 wherein the amount of oil is from about 0.1% by weight to about 15% by weight, based upon the weight of the flexible gelled food product, the acidic antioxidant comprises ascorbic acid for preventing oxidation of said omega-3 fatty acids, said polyol comprises glycerin, and the weight ratio of the total amount of acidic antioxidant to the amount of said oil is from about 0.003 to about 1.0.

57. A method as claimed in claim 56 wherein said oil comprises omega-3 fatty acids, said gellable composition comprises a methylcelluolose gel, an hydroxymethylcellulose gel, an hydroxypropylmethylcellulose gel, a pectin, a modified starch gel, or mixtures thereof, and said admixing is at a temperature of less than about 180° F.

58. A method as claimed in claim 56 wherein the homogeneous mixture is extruded into strips or molded in a starch mold.

59. A method as claimed in claim 37 wherein the gel base composition is cooled prior to admixing with the oil.
